(19) United States
(12) Patent Application Publication
(10) Pub. No.: US 2019/0199886 A1
(43) Pub. Date: Jun. 27, 2019

(54) IMAGE PROCESSING APPARATUS AND COMPUTER PROGRAM

(71) Applicant: Konica Minolta, Inc., Tokyo (JP)

(72) Inventors: Hidetaka IWAI, Itami-shi, Hyogo (JP); Yuji OKAMATO, Amagasaki-shi, Hyogo (JP); Atsushi TAMURA, Tokyo (JP)

(73) Assignee: Konica Minolta, Inc., Tokyo (JP)

(21) Appl. No.: 16/229,030

(22) Filed: Dec. 21, 2018

(30) Foreign Application Priority Data
Dec. 22, 2017 (JP) 2017-245840

(51) Int. Cl. H04N 1/32; H04N 1/00; H04N 1/04; G06F 21/60

(52) U.S. Cl. CPC H04N 1/32101; G06F 21/608; H04N 1/04; H04N 1/00352

(57) ABSTRACT

An image processing apparatus that performs a job of converting an image of a document into data and transmitting the generated image data includes: a display that displays a screen on which a user designates a transmission destination; a calculator that calculates a predicted time taken to perform the job under each of a plurality of conditions having mutually different setting values in converting the image into image data; a display controller that controls to display the predicted times individually calculated for the plurality of conditions on the display; and a job execution controller that controls to execute the job under a selected condition out of the plurality of conditions.

The entire disclosure of Japanese patent Application No. 2017-245840, filed on Dec. 22, 2017, is incorporated herein by reference in its entirety.

### BACKGROUND

### Technological Field

The present invention relates to an image processing apparatus and a computer program.

### Description of the Related Art

With the use of an image processing apparatus such as an image reader, a facsimile machine, and a multi-functional peripheral (MFP, also referred to as a multi-functional machine) integrating these functions, it is possible to execute a job of converting an image recorded on a document such as a paper document into data and transmitting generated image data to an external device.

A user of an image processing apparatus of this type performs operation of setting a document on the image processing apparatus and inputting a job by specifying a transmission destination. At that time, the user can designate several conditions besides the transmission destination, as conditions for the job. For example, resolution in data generation can be designated.

One of the known techniques for simplifying complicated operation at job input is a technique described in JP 2013-153536 A. JP 2013-153536 A discloses a technique of selectably displaying a plurality of scan settings (a group of setting values defined for a plurality of items) for a transmission destination in accordance with selection of the transmission destination.

Meanwhile, JP 2003-023526 A discloses a technique of performing control of switching document reading modes according to temperature in order to provide the user with comprehensively optimum productivity in scanning using a network.

The user sometimes wishes to complete a job of transmitting image data of the document in a shortest possible time. For example, there is a case where a request for urgent transmission from a customer or a chief is received, or a case where it is desired to transfer a document necessary for a meeting during a business trip to one's portable computer immediately before leaving on the business trip.

In this case, however, there is a problem that the user has insufficient knowledge about what conditions should be designated to complete the job faster, leading to a waste of time due to difficulty in finding appropriate operation.

There is another case where the user wants to confirm job completion although the user is not in a hurry. For example, there is a case where the user desires to have a meeting with another party by using image data as soon as the image data arrives at the other party. Job completion can be confirmed by displaying job history. However, the time taken for the job might sometimes be longer than the time expected by the user. At this time, there is a possibility that the user might wastefully check the history until job completion.

### SUMMARY

The present invention is made in view of the above-described problem and an object of the present invention is to provide an image processing apparatus more convenient than a conventional image processing apparatus for a user who wishes to know the time requirement for a job at job input.

To achieve the above mentioned object, according to an aspect of the present invention, an image processing apparatus that performs a job of converting an image of a document into data and transmitting the generated image data reflecting one aspect of the present invention comprises: a display that displays a screen on which a user designates a transmission destination; a calculator that calculates a predicted time taken to perform the job under each of a plurality of conditions having mutually different setting values in converting the image into image data; a display controller that controls to display the predicted times individually calculated for the plurality of conditions on the display; and a job execution controller that controls to execute the job under a selected condition out of the plurality of conditions.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of appearance of an image processing apparatus according to an embodiment of the present invention;

FIG. 2 is a diagram schematically illustrating a hardware configuration of an image processing apparatus;

FIG. 3 is a diagram illustrating a functional configuration of an image processing apparatus;

FIG. 4 is a diagram illustrating an example of a destination input screen;

FIG. 5 is a diagram illustrating an example of a destination registration table:

FIG. 6 is a diagram illustrating an example of a destination division table:

FIG. 7 is a diagram illustrating an example of a condition table;

FIGS. 8A to 8C are diagrams each illustrating an example of a condition selection screen;

FIG. 9 is a diagram illustrating an example of a per-sheet time requirement table;

FIGS. 10A and 10B are diagrams each illustrating an example of a condition selection screen;

FIGS. 11A to 11C are diagrams each illustrating an example of a condition selection screen:

FIGS. 12A and 12B are diagrams each illustrating an example of a condition selection screen;

FIG. 13 is a diagram illustrating a processing flow in an image processing apparatus;

FIG. 14 is a diagram illustrating a condition limiting processing flow;

FIG. 15 is a diagram illustrating a condition display processing flow; and

FIG. 16 is a diagram illustrating a condition change processing flow.

### DETAILED DESCRIPTION OF EMBODIMENTS

Hereinafter, one or more embodiments of the present invention will be described with reference to the drawings. However, the scope of the invention is not limited to the disclosed embodiments.

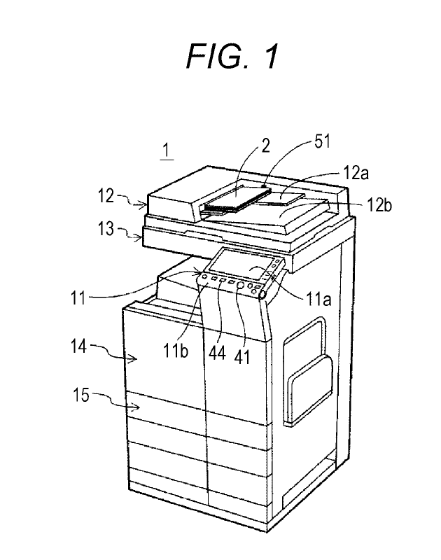

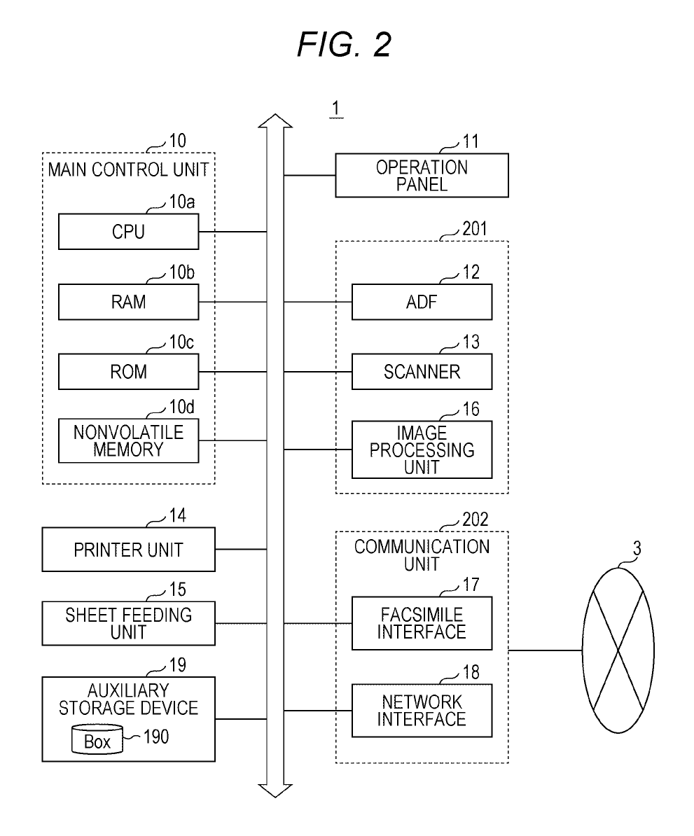

FIG. 1 illustrates an example of an external appearance of an image processing apparatus 1 according to an embodiment of the present invention. FIG. 2 schematically illustrates a hardware configuration of the image processing apparatus 1.

The image processing apparatus 1 is a multi-functional peripheral (MFP, also referred to as a multi-functional machine) integrating functions of a copier, an image reader, a facsimile machine, or the like. As illustrated in FIG. 1, the image processing apparatus 1 includes an operation panel 11, an automatic document feeder (ADF) 12, a flatbed scanner 13, a printer unit 14, and a sheet feeding unit 15. The image forming apparatus 1 further includes, as illustrated in FIG. 2, a main control unit 10, an image processing unit 16, a facsimile interface 17, a network interface 18, and an auxiliary storage device 19.

The image processing apparatus 1 can communicate with external devices via a communication line 3. The communication line 3 is implemented by the Internet, an Ethernet (registered trademark) line, a wireless local area network (LAN) line, a public line, a dedicated line, or the like.

The operation panel 11 includes a touch panel display 11a for displaying a screen for user's operation and a key input unit 11b on which hardware keys such as a start key 41 and a scan key 44 are arranged, and outputs a signal in response to input operation. In particular, the touch panel display 11a outputs a signal indicating a touched position on a display surface. In accordance with the signal output from the operation panel 11, the main control unit 10 controls operation of the image processing apparatus 1.

The automatic document feeder 12 conveys a sheet-like document 2 set in a document tray 12a to a flow reading position of the scanner 13. Conveyance is further continued and the document 2 is discharged to a sheet discharge tray 12b. In a case where there is a plurality of documents 2, the sheet is extracted one at a time from the document tray 12a to be conveyed. The automatic document feeder 12 is provided so as to be opened and closed as a cover covering platen glass of the scanner 13.

The automatic document feeder 12 includes a sensor 51 that detects the number of documents 2 set in the document tray 12a. The sensor 51 outputs a detection signal corresponding to the thickness or the weight of the set sheet bundle. In accordance with this detection signal, the main control unit 10 detects the number of documents 2. That is, calculation is performed to divide the detected thickness or weight by an average thickness or average weight per standard sheet so as to detect an approximate number of sheets.

The scanner 13 reads an image of the document 2 conveyed from the automatic document feeder 12 or a document set on the platen glass by the user, and outputs image data. It is possible to read in monochrome (gray scale) and full color.

The scanner 13 includes a sensor that detects the presence or absence of a document on the platen glass in a state where the automatic document feeder 12 is open.

The printer unit 14 prints an image read by the scanner 13 in a copy job on one side or both sides of a sheet (recording sheet) supplied from the sheet feeding unit 15. The printer unit 14 is also applicable for printing documents input from an external host or read out from a box 190 in the auxiliary storage device 19 or images received by facsimile communication. The printing method is an electrophotographic method, for example, enabling monochrome printing and full color printing.

The sheet feeding unit 15 includes a plurality of sheet feed trays capable of storing a large number of sheets, and extracts a sheet from a selected sheet feed tray and supplies the sheet to the printer unit 14.

The main control unit 10 is responsible for overall control of the image processing apparatus 1. The main control unit 10 includes a CPU 10a, a RAM 10b, a ROM 10c, and a nonvolatile memory 10d.

The ROM 10c or the nonvolatile memory 10d stores software for controlling the automatic document feeder 12, the scanner 13, the printer unit 14, etc., in order to operate the image processing apparatus 1 as a copier, a facsimile machine, an image reader, or the like. This software includes a scan transmission program 10P that controls operation related to a scan transmission job to be described below. The scan transmission program 10P or other control programs are loaded into the RAM 10b as necessary and executed by the CPU 10a.

The image processing unit 16 applies processing related to characteristics of a reading optical system, such as shading correction and chromatic aberration correction, onto the image data transmitted from the scanner 13. The image processing unit 16 further performs processing such as data format conversion, compression/decompression of image data at exchanging the image data between the CPU 10a and the auxiliary storage device 19, and encryption of the image data for enhancing security of communication, or the like.

The image processing unit 16, the automatic document feeder 12, and the scanner 13 configure a transmission data generation unit 201 that reads an image of a paper medium from the document 2 and converts the image into transmission data of a format designated by the job.

The facsimile interface 17 is an interface for exchanging image data with an external facsimile terminal using a protocol such as G3. The communication line 3 is implemented as a telephone line, and the Internet.

The network interface 18 is an interface for communicating with an external information processing apparatus such as a personal computer, a server, and a smartphone via the communication line 3. The communication line 3 is implemented by a local area network line (LAN line), the Internet. or the like.

The facsimile interface 17 and the network interface 18 constitute a communication unit 202 that transmits the transmission data generated by the transmission data generation unit 201 to an external device.

The auxiliary storage device 19 stores image data transferred from the main control unit 10, data of a document transferred from an external device, or the like. The auxiliary storage device 19 is implemented by a hard disk drive (HDD), a solid state drive (SSD), or the like.

The auxiliary storage device 19 includes a box 190 being a storage region related to the box function. A box function is a function of allocating a storage region referred to as “My Box” or “Personal Box” for each of users, and storing and managing image data or the like by each of user's own storage regions. The box 190 may be provided for each of groups so as to be shared by members of the group. The box 190 corresponds to a “folder” or a “directory” in a personal computer.

The image processing apparatus 1 is capable of executing a scan transmission job of converting an image recorded in the document 2 into data and transmit the image data. The scan transmission job is classified into a plurality of jobs depending on the communication method or the type of the transmission destination (destination). Specifically, the scan transmission job includes fax transmission, e-mail transmission, file storage in box 190, and file transmission to a server. Fax transmission is implemented by using a telephone line, using the Internet, or transmission to an IP address. File transmission is classified by the protocol to be used. Examples of the protocol include a Server Message Block (SMB), a File Transfer Protocol (FTP), and Web-based Distributed Authoring and Versioning (Web-DAV).

The scan transmission program 10P makes it possible to present the job conditions and approximate corresponding time requirement to the user when the user performs operation of inputting scan transmission jobs. The function of presenting such conditions and time requirement will be described as a “condition designation support function”. Hereinafter, a configuration and operation of the image processing apparatus 1 will be described focusing on this condition designation support function. For convenience of explanation, it is assumed that one or a plurality of documents 2 is set in the document tray 12a of the automatic document feeder 12 in the scan transmission job, and the size of the document 2 is a fixed size, for example, A4 size.

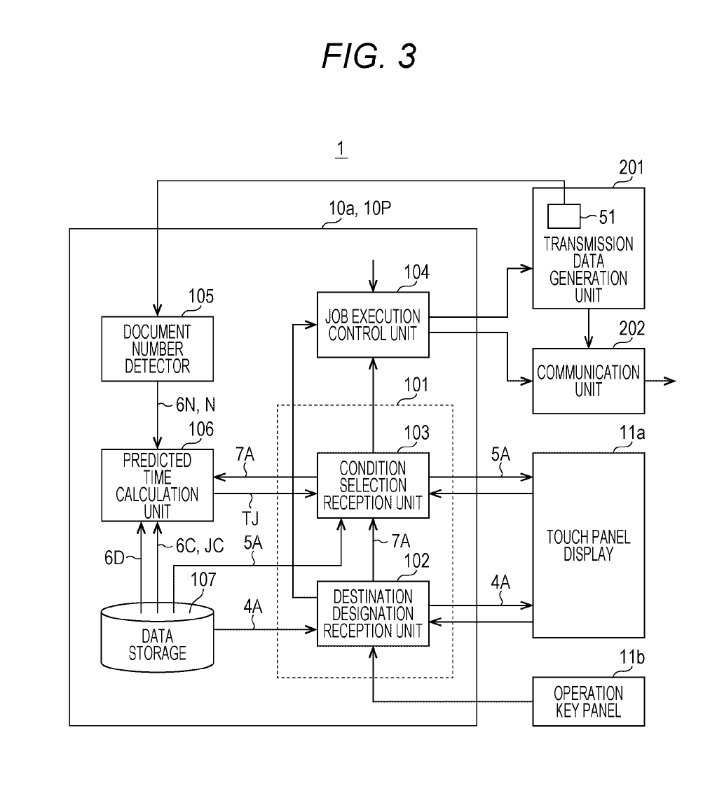

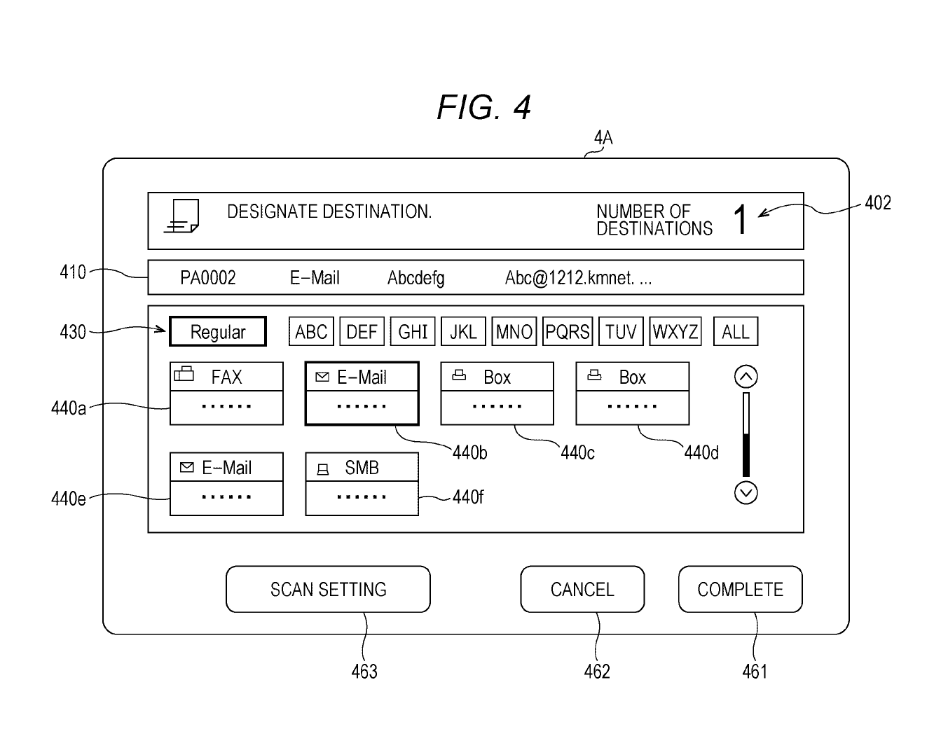

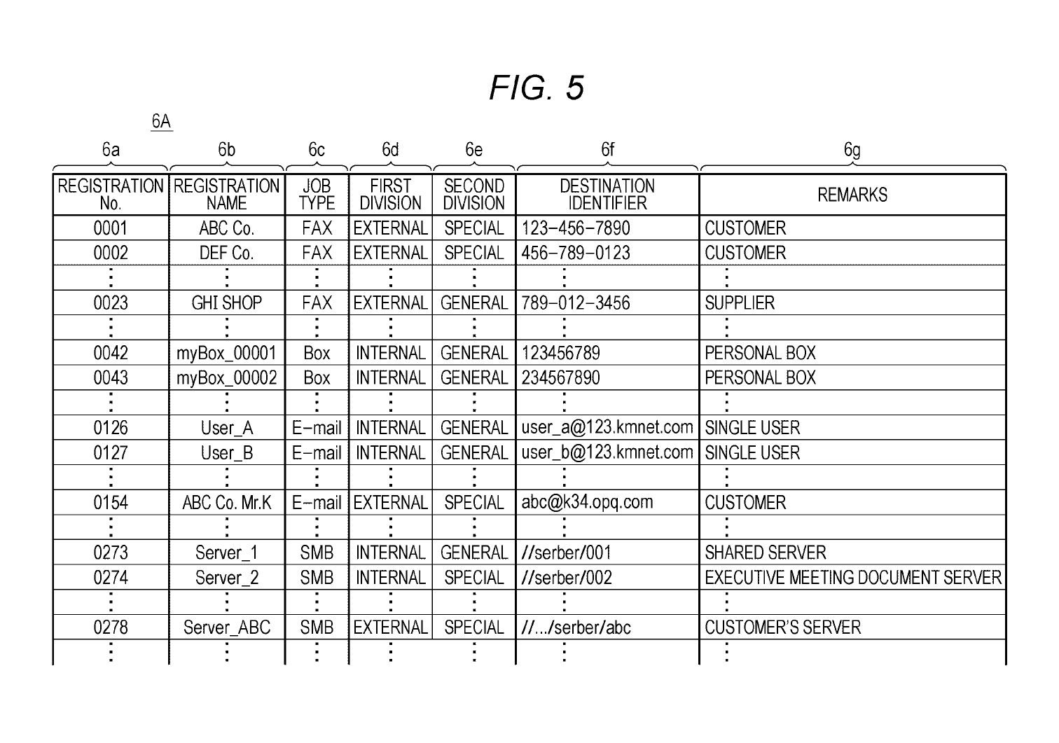

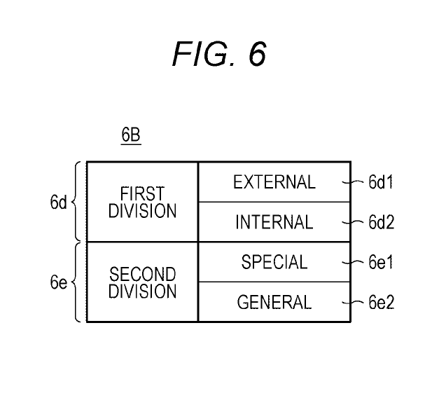

FIG. 3 illustrates an example of a functional configuration of the image processing apparatus 1. FIG. 4 illustrates an example of a destination input screen 4A. FIG. 5 illustrates an example of a destination registration table 6A. FIG. 6 illustrates an example of a destination division table 6B.

As illustrated in FIG. 3, the scan transmission program 10P is executed to implement functions such as a display control unit 101, a job execution control unit 104, a document number detector 105, a predicted time calculation unit 106, and a data storage 107, onto the image processing apparatus 1. The display control unit 101 includes a destination designation reception unit 102 and a condition selection reception unit 103.

A user sets the document 2 recording an image to be transmitted on the document tray 12a of the automatic document feeder 12. Before or after this setting operation, the user presses the scan key 44 of the operation panel 11 to select the scan function.

When the document 2 is set, the document number detector 105 performs the above-described division on the basis of the signal from the sensor 51 of the document tray 12a and the average thickness or average weight per sheet stored in advance, so as to detect the number N of the set documents 2. The document number detector 105 subsequently transmits number of sheets data 6N indicating the detected number of sheets N to the predicted time calculation unit 106. The document number detector 105 is an example of a detector that detects the number of documents 2.

Meanwhile, when the scan function is selected by the user, the destination designation reception unit 102 causes the touch panel display 11a to display the destination input screen 4A as illustrated in FIG. 4. The destination designation reception unit 102 then performs processing for receiving an input of a destination (transmission destination) by the user.

The destination input screen 4A displays buttons such as a destination display switching button row 430 and a destination selection button 440 corresponding to all or a part of previously registered destinations, a completion button 461, a cancel button 462, and a scan setting button 463. In an initial display, as illustrated in FIG. 4, destination selection buttons 440a, 440b, 440c, 440d, 440e, and 440f belonging to a regular group (Regular) with high selection frequency are displayed. Each of the destination selection buttons 440a to 440f displays the job type and the registered name in the forms of button names.

The user touches a destination selection button (for example, 440b) corresponding to a desired destination. Then, the destination designation reception unit 102 highlights on a display the touched destination selection button 440b so as to be distinguished from other destination selection buttons, while presenting registration information related to the destination to the user in the display region 410. Furthermore, the number 402 indicating the number of designated destinations is updated.

The user can designate two or more destinations. At that time, the user touches any of the buttons in the destination display switching button row 430 to switch the display of the destination selection button as necessary.

When the user touches the completion button 461, the destination designation reception unit 102 notifies the job execution control unit 104 of the destination designated up to that point. Thereafter, when the user presses the start key 41 on the operation key panel 11b, the execution of the scan transmission job is started under the control of the job execution control unit 104. When the user touches the cancel button 462 before pressing the start key 41, designation of the destination up to that point is canceled.

The user can also change the job condition to a condition different from the default condition. In that case, the user touches the scan setting button 463. The destination designation reception unit 102 notifies the condition selection reception unit 103 that the scan setting button 463 has been touched. This notification includes destination designation data 7A indicating a destination designated up to that point. Job condition change will be described in detail below.

Returning to FIG. 3, in response to notification that the scan setting button 463 has been touched, the condition selection reception unit 103 causes the touch panel display 20e to display the condition selection screen 5A in place of the destination input screen 4A. The condition selection reception unit 103 subsequently supplies the destination designation data 7A to the predicted time calculation unit 106 and thereby requesting calculation of the time requirement.

In response to the request, the predicted time calculation unit 106 calculates predicted time TJ taken to perform a job under each of a plurality of conditions with mutually different setting values for conversion into image data for the document 2. At this time, a plurality of conditions JC corresponding to the destination is selected from a condition table 6C stored by the data storage 107. Calculating operation uses the number of sheets N indicated in the number of sheets data 6N from the document number detector 105. Next, the predicted time calculation unit 106 transmits the calculated a plurality of predicted times TJ to the condition selection reception unit 103.

After receiving the predicted time TJ, the condition selection reception unit 103 controls the touch panel display 11a so as to display, on the same screen, the predicted times TJ individually calculated for the plurality of conditions JC as options for selecting one of the plurality of conditions JC on the condition selection screen 5A.

Furthermore, the condition selection reception unit 103 controls to display the plurality of calculated predicted times TJ and the condition JC corresponding to the selected predicted time TJ out of the plurality of conditions JC on the same screen. At this time, the setting value of the condition JC corresponding to the selected predicted time TJ is displayed as an operation button for instructing to change the condition JC.

Furthermore, in a case where a plurality of destinations is designated by the user, that is, in a case where the destination designation data 7A indicates a plurality of destinations, the condition selection reception unit 103 controls to sequentially display the predicted times TJ for individual destinations.

When operation to finalize the selection of the predicted time TJ is performed on the condition selection screen 5A, the condition selection reception unit 103 notifies the job execution control unit 104 of this operation.

When the start key 41 has been pressed, the job execution control unit 104 controls the transmission data generation unit 201 and the communication unit 202 to respectively perform a scan transmission job of first converting the image of the document 2 into data under the condition JC selected by the user and then transmitting the data to the destination specified by the user. Note that in a case where the destination is the box 190, the job execution control unit 104 controls data transfer between the transmission data generation unit 201 and the auxiliary storage device 19, that is, controls communication within the image processing apparatus 1, instead of controlling the communication unit 202.

As illustrated in FIG. 5, the destination registration table 6A displays a registration number 6a given in the order of registration, a registered name 6b, a job type 6c, a first division 6d, a second division 6e, a destination identifier 6f, and remarks 6g, associated for each of destinations.

The job type 6c is a classification according to the communication method or the type of the transmission destination, and includes fax transmission (FAX), e-mail transmission (E-mail), storing in the box 190 (Box), and file transmission by SMB (SMB).

The first division 6d is a division that divides the destination into two in view of data security. As illustrated in the destination division table 6B in FIG. 6, a first division 6d divides the destinations into “external” as a first group 6d1 needing data encryption and “internal” as a second group 6d2 which does not need encryption.

A second division 6e is a division that divides the destination into two in view of color quality of the image. The second division 6e divides the destinations into “special” as a third group 6e1 needing full color reading and “general” as a fourth group 6e2 not needing full color reading.

In the present embodiment, the first division 6d and the second division 6e each divide the destinations independently of each other as described above. Accordingly, each of destinations belongs to either “external” or “internal”, and belongs to either “special” or “general”.

The destination identifier 6f is information for uniquely specifying a destination such as a telephone number, an e-mail address, a Uniform Resource Locator (URL), or the like. The remarks 6g corresponds to information related to destinations appropriately recorded as necessary.

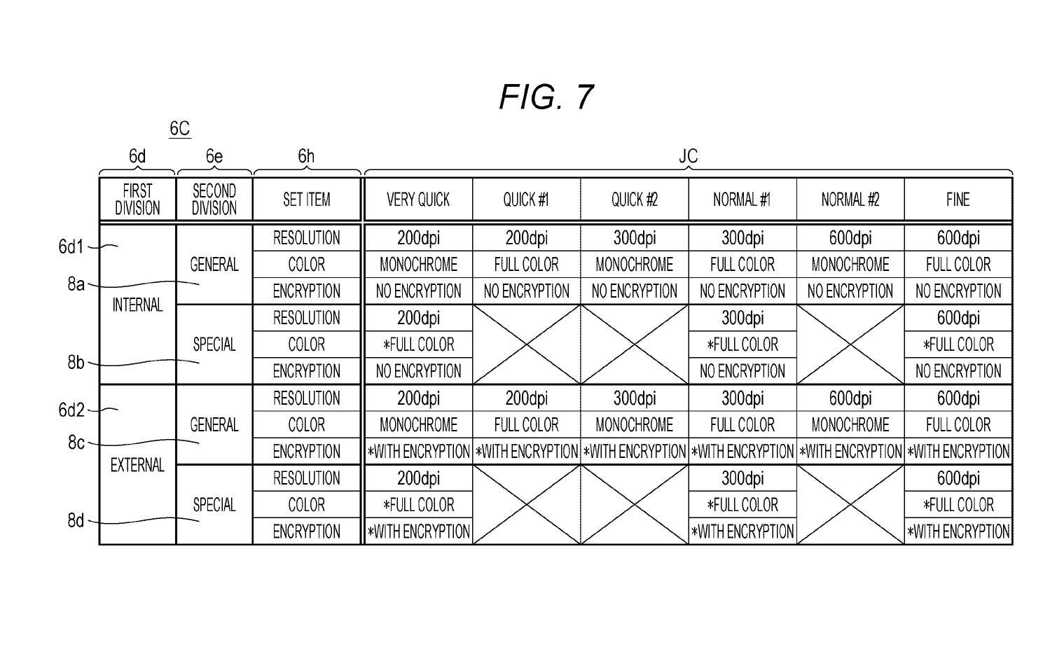

FIG. 7 illustrates an example of the condition table 6C.

The condition table 6C is a table illustrating conditions JC designatable by the user for each of four subgroups 8a, 8b, 8c, and 8d distinguished by both the first division 6d and the second division 6e.

In the present embodiment, items (setting items) 6h of the condition JC include three items of “resolution”, “color”, and “encryption”. The user can select the setting value of each of these items 6h from among the individual options. The selection operation can also be omitted. In a case where the selection operation is omitted, a default setting value corresponding to the job type is automatically selected.

The options of “resolution” setting values related to image reading are 200 dpi, 300 dpi, and 600 dpi. The higher the resolution, the slower the conveyance of the document 2 by the automatic document feeder 12, resulting in more time taken to read.

The options of the setting value of “color” related to the data amount are monochrome and full color. Full color setting needs more data amount than in monochrome setting, resulting in more time taken for processing performed by the image processing unit 16 and data transmission performed by the communication unit 202, or the like.

Options of the setting value of “encryption” related to data processing are With Encryption, or No Encryption. In the case of With Encryption, it would include encryption processing and thus, the time requirement for the job is longer than in the case of No Encryption.

The condition JC is a combination of setting values of the three items 6h in this manner. Since resolution, color, and encryption setting values have three, two and two options, respectively, there are 3×2×2 sets of combinations, that is, 12 (12 combinations) conditions JC.

Meanwhile, the condition table 6C has classification such that the plurality of conditions JC is classified into a plurality of courses determined in consideration of the length of time taken to perform the scan transmission job. The plurality of courses includes six courses as “very quick course”, “quick course #1”, “quick course #2”, “normal course #1”, “normal course #2”, and “fine course”.

A very quick course is the shortest course of the six courses. This is because the resolution is set to a setting value as a minimum value (200 dpi), and the color is set to a setting value of monochrome.

The fine course is the longest course. This is because the resolution is set to a setting value as a maximum value (600 dpi), and the color is set to a setting value of full color.

Normal course #1 is a course that is longer than a very quick course, but not longer than the fine course. In the normal course #1, resolution is set to a setting value as an intermediate value (300 dpi), and color is set to a setting value of full color.

A quick course #1 and a quick course #2 are courses that is longer than the very quick course but shorter than normal course #1. Note that the quick course #1 is sometimes shorter or longer than the quick course #2. This is because while 200 dpi in the very quick course #1 is more advantageous in terms of time reduction than 300 dpi in the very quick course #2 regarding resolution, monochrome in very quick course #2 is more advantageous in terms of time reduction than full color in the very quick course #1 regarding color setting value.

The normal course #2 is a course longer than the quick course #1 and the quick course #2 but not longer than the fine course. The normal course #2 sometimes longer than or sometimes shorter than the normal course #1. The reason is similar to the case of the quick course #1 and the quick course #2.

The condition table 6C specifies the condition JC for each of the six courses onto destinations in the subgroup 8a and the subgroup 8c, that is, the destinations each having the second division “general”.

In contrast, the condition table 6C specifies the condition JC for each of three courses of the very quick course, the normal course #1, and the fine course among the six courses onto the subgroup 8b and the subgroup 8d, that is, the destinations each having the second division “special”. The reason why the condition JC is not specified for the quick course #1, the quick course #2, and the normal course #2 is that the setting values of the color of these subgroups 8b and 8d are limited to full color. The symbol “*” in the figure indicates that it is limited to the setting value illustrated in the figure.

The condition JC with the setting value of No Encryption is specified to the subgroup 8b while the condition JC with a setting value of With Encryption is specified to the subgroup 8d. By limiting the setting value of the color to full color, the condition JC that can be allocated to each of the subgroup 8b and the subgroup 8d is three conditions JC corresponding to the very quick course, the normal course #1, and the fine course.

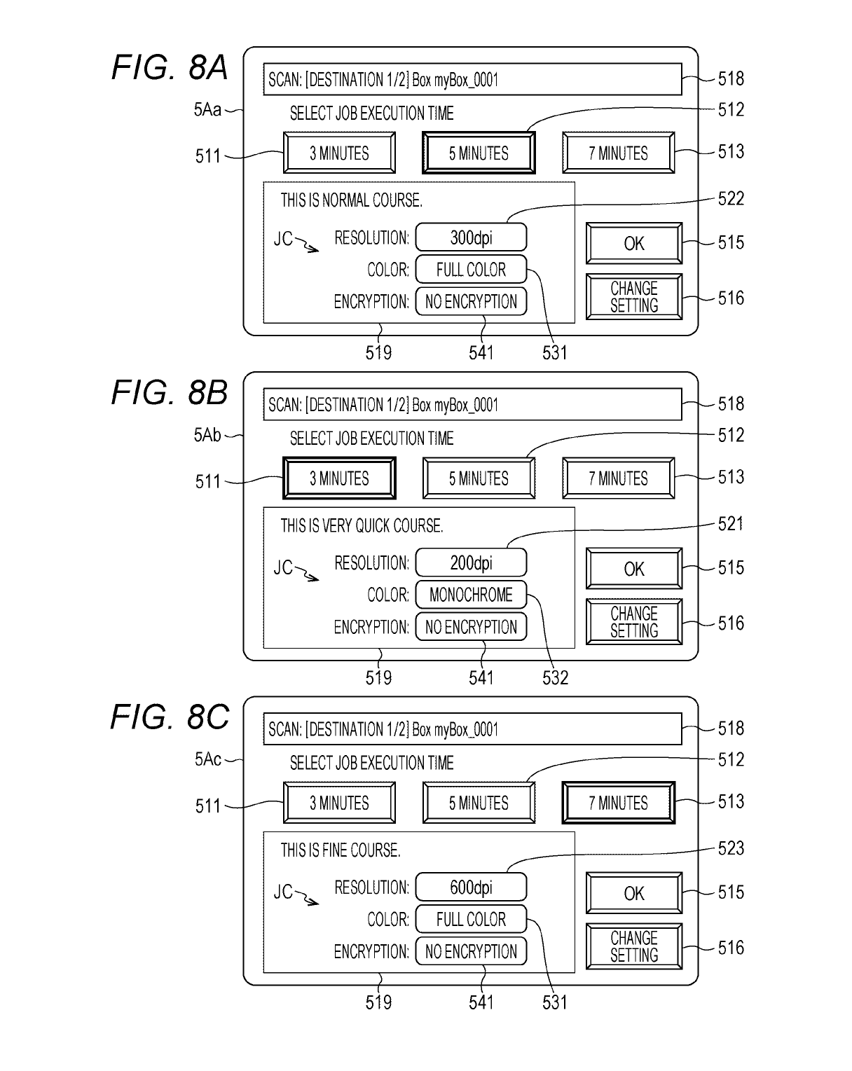

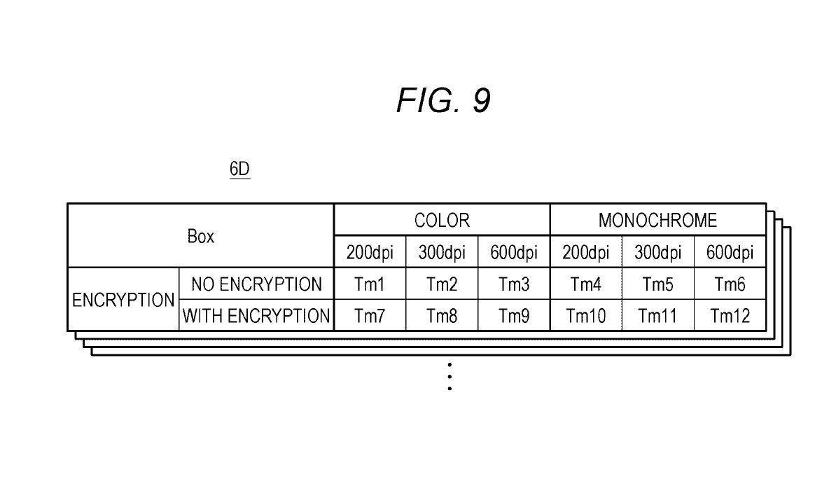

FIGS. 8A to 8C illustrate an example of the condition selection screen 5A, and FIG. 9 illustrates an example of a per-sheet time requirement table 6D.

Each of condition selection screens 5Aa, 5Ab, and 5Ac illustrated in FIGS. 8A to 8C includes three time selection buttons 511, 512, and 513, an OK button 515, a setting change button 516, a destination display region 518, a condition display region 519, or the like.

The time selection buttons 511, 512, and 513 each correspond to the very quick course, the normal course #1, and the fine course respectively determined to be display targets among the six courses in this order, with the predicted time TJ calculated by the above-described predicted time calculation unit 106 being displayed in the form of a button name.

Calculation of the predicted time TJ uses the per-sheet time requirement table 6D illustrated in FIG. 9 as a reference. The per-sheet time requirement table 6D is provided for each of job types and lists per-sheet time requirements Tm 1 to Tm 12 each being average time requirement per document when a job is executed under each of the above 12 conditions JC.

The per-sheet time requirements Tm 1 to Tm 24 can be obtained by executing a scan transmission job under each of the conditions JC with a plurality of test sheets as the document 2 for each of job types and measuring the time taken to complete the job.

For example, the per-sheet time requirement Tm 1 can be obtained as follows. An image is read from a plurality of documents 2 at 200 dpi in full color and stored in the box 190 without encryption and the time taken from the start of the conveyance of the document 2 to the completion of storing the data is measured. A value obtained by dividing the measured time by the number N of sheets of the document 2 is calculated as the per-sheet time requirement Tm 1.

The per-sheet time requirement table 6D may be stored in the data storage 107 or the like.

The predicted time calculation unit 106 calculates the predicted time corresponding to the condition JC of each of the three display target courses to be displayed out of the per-sheet time requirements Tm 1 to Tm 24 listed in the per-sheet time requirement table 6D corresponding to the destination designated by the user. The predicted time calculation unit 106 subsequently calculates the predicted time TJ by using the following calculation formula including the number of sheets N, as a variable.

TJ=Tm×N

That is, the product of the selected per-sheet time requirement Tm and the number of sheets N indicated in the number of sheets data 6N is calculated as the predicted time TJ.

For example, in the normal course #1, in a case where the setting values of individual items of the condition JC are set as “300 dpi”, “Full color”, “(No Encryption)” and the number of sheets N is “3”, the product of per-sheet time requirement Tm 2 and “3” is to be calculated as the predicted time TJ.

In the examples of FIGS. 8A to 8C, predicted times TJ of 3 minutes, 5 minutes, and 7 minutes calculated for the three courses are displayed.

The destination display region 518 displays a registered name of a destination designated by the user. In the example of FIGS. 8A to 8C, the destination has been registered in the destination registration table 6A of FIG. 5 with “0042” as the registration number 6a and “myBox_0001” as the registered name.

The condition display region 519 displays the condition JC corresponding to the selected one course among the three courses (very quick course, the normal course #1, and the fine course). Specifically, the current setting value of each of items of the condition JC is displayed as a button name of each of the operation buttons 521, 522, 531, 532, and 541.

For example, when the condition selection screen 5A is to be displayed for the first time after designation of the destination, the condition selection reception unit 103 automatically selects, for example, the normal course #1 among the three courses and displays the condition JC of the normal course “1 without receiving an instruction from the user. In the example of FIGS. 8A to 8C, the first division 6d of the destination is “internal” and the second division 6e is “general” (refer to FIG. 5). That is, this job belongs to the subgroup 8a in the condition table 6C in FIG. 7. Therefore, as illustrated in FIG. 8A, the initial display displays “300 dpi”, “Full color”, “No Encryption)” condition JC representing the condition JC that is allocated to the subgroup 8a and corresponds to the normal course #1, as the button names of the operation buttons 522, 531, and 541, respectively. At this time, the time selection button 512 corresponding to the normal course #1 is highlighted to be distinguished from the other two time selection buttons 511 and 513.

Touching by the user on the OK button 515 in a state where the condition selection screen 5Aa of FIG. 8A is displayed indicates an input of the end of selection of the condition JC. In this case, a job is performed under the condition JC of the normal course #1.

In another case where the user wishes to complete the job in time less than 5 minutes in a state where the condition selection screen 5Aa is displayed, the user touches the time selection button 511 displaying “3 minutes. In response to this, the condition selection screen 5Ab illustrated in FIG. 8B is displayed instead of the condition selection screen 5Aa. The condition selection screen 5Ab displays “200 dpi”, “Monochrome”. “No Encryption)” representing the condition JC corresponding to the very quick course, as the button names of the operation buttons 521, 532, and 541, respectively.

The user confirms the displayed condition JC, and in a case where the user judges it is OK to execute the job under this condition JC, the user touches the OK button 515. This indicates an input of the end of the selection of the condition JC. In this case, the job is performed under the condition JC defined for the very quick course.

When the user touches the time selection button 511 displaying as “7 minutes” in a state where the condition selection screen 5Aa or the condition selection screen 5Ab is displayed, the condition selection screen 5Ac illustrated in FIG. 8C is displayed instead of the condition selection screen 5Aa or 5Ab.

The condition selection screen 5Ac displays “600 dpi”. “Full color”. “No Encryption” representing the condition JC corresponding to the fine course, as the button names of the operation buttons 523, 531, and 541, respectively. The user may touch the OK button 515 to perform the job at the condition JC for the fine course, or touch the time selection button 511 to display the condition selection screen 5 Ab, or touch the time selection button 512 to display the condition selection screen 5Aa.

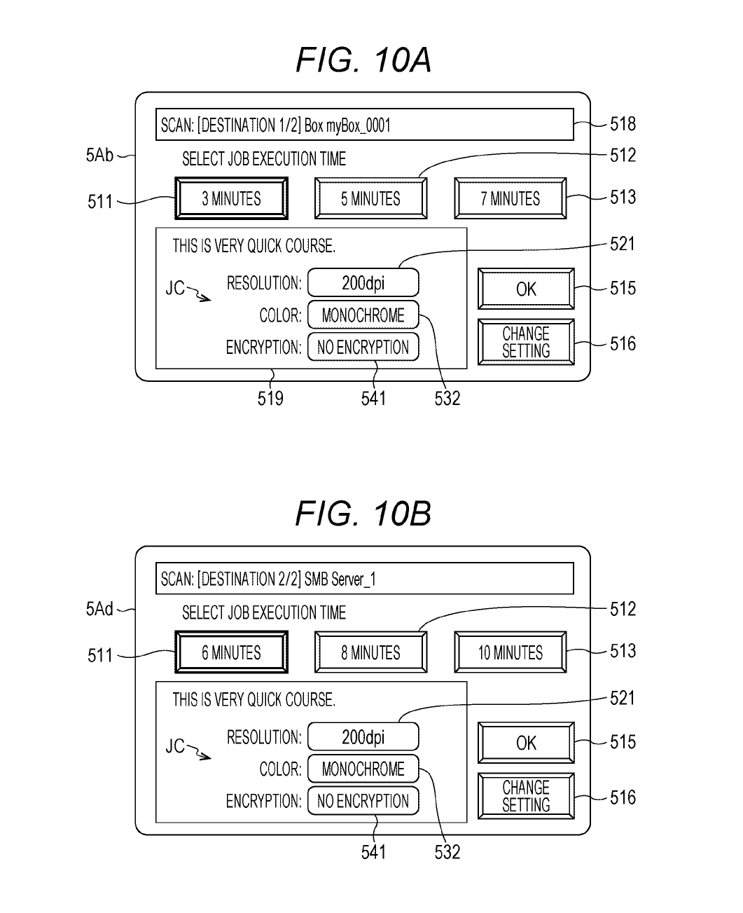

FIGS. 10A and 10B, 11A to 11C, and 12A and 12B each illustrate other examples of the condition selection screen 5A.

In the examples of FIGS. 10A and 10B, two destinations are designated. These destinations belong to a same subgroup, for example the subgroup 8a. In other words, it is possible to execute the job under the same condition JC. In this, however, the job types are mutually different. One job type is “Box”, that is, a job of performing transmission to a destination inside the image processing apparatus 1 while the other job type is “SMB”, a job of performing transmission to an external destination of the image processing apparatus 1.

Since the job types are different, the jobs are to be executed under the same condition JC but mutually different predicted times TJ.

That is, as illustrated in FIG. 10A, the predicted times TJ of 3 minutes, 5 minutes, and 7 minutes are displayed for the very quick course, the normal course #1, and the fine course, respectively, on the condition selection screen 5Ab in the case of “Box”.

In contrast, as illustrated in FIG. 10B, the predicted times TJ of 6 minutes, 8 minutes, and 10 minutes are displayed for the very quick course, the normal course #1, and the fine course, respectively, on the condition selection screen 5Ad in the case of “SMB”.

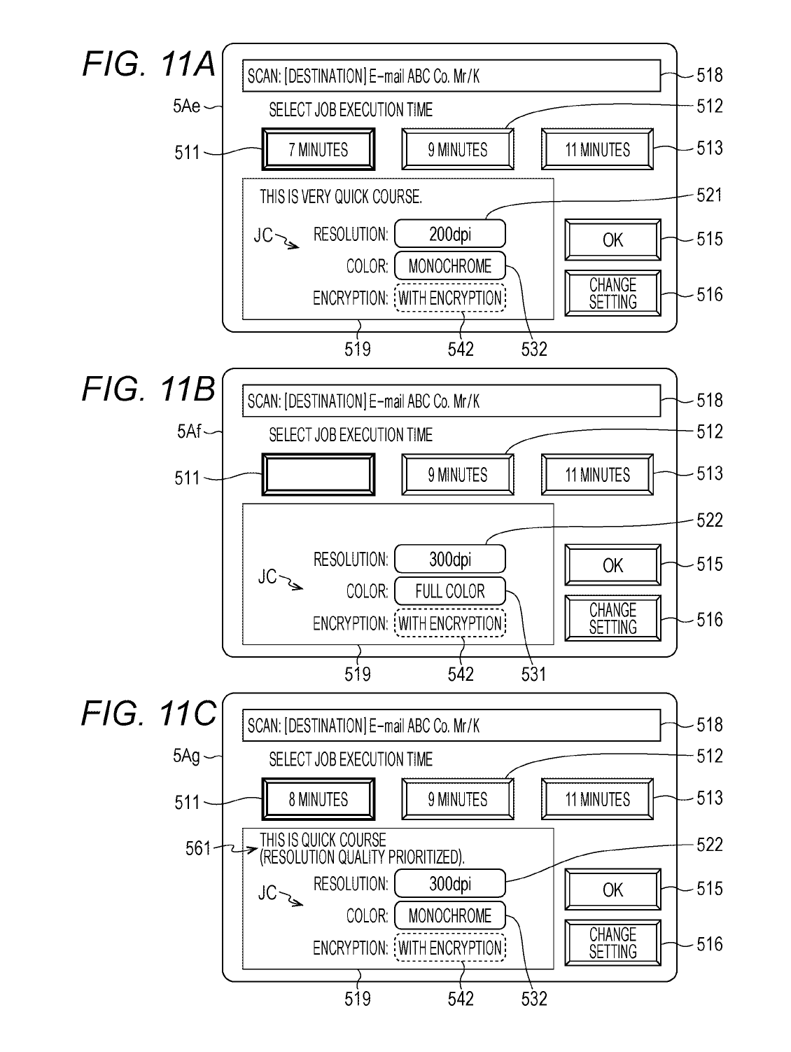

The examples of FIGS. 11A to 11C are examples in which the user individually changes the setting value of each of the items of the condition JC on the condition selection screen 5A. In FIGS. 11A to 11C, it is assumed that the destination belongs to the subgroup 8c.

On a condition selection screen 5Ae illustrated in FIG. 11A, the predicted times TJ of 7 minutes, 9 minutes, and 11 minutes are displayed for the very quick course, the normal course #1, and the fine course, respectively. The condition selection screen 5Ae also displays “200 dpi”, “Monochrome”, “With Encryption” representing the condition JC corresponding to the very quick course, as the button names of the operation buttons 521, 532, and 542, respectively. Note that for the destinations belonging to the subgroup 8a, since the setting value of the encryption is limited to “With Encryption”, the operation button 542 is displayed so as to indicate that the setting value is unchangeable. This display is indicated by being grayed out, for example.

By touching the operation buttons 521 and 532, the user can instruct to change the setting value for the resolution or the color. Each time the operation buttons 521 and 532 are touched, the button names are switched in rotation. That is, the resolution is switched in the order of 200 dpi, 300 dpi, to 600 dpi, and return to 200 dpi. For color, it switches from Monochrome to Full color and return to Monochrome. Encryption setting is also switched, if changeable, from With Encryption, to No encryption, and return to With Encryption.

After the user touches the operation buttons 521 and 532, the display of the button name of the time selection button 511, that is, the predicted time TJ calculated for the very quick course disappears as illustrated in the condition selection screen 5Af in FIG. 11B. This is due to the display control of preventing the user from misunderstanding that the predicted time TJ remain unchanged even when the setting value has changed.

In response to the touch by the user on the setting change button 516 in a state where a setting value different from the original setting value is displayed in the condition display region 519, the predicted time TJ corresponding to the condition JC including the setting value of the state is calculated. Together with this, as illustrated in the condition selection screen 5Ag in FIG. 11C, the calculated predicted time TJ (for example, 8 minutes) is displayed as the button name of the time selection button 511.

As a result of the user's change of the setting value, the condition JC corresponding to the time selection button 511 on the condition selection screen 5Ag becomes the same condition as the condition of the quick course #2. The condition display region 519 displays a message 561 notifying this information.

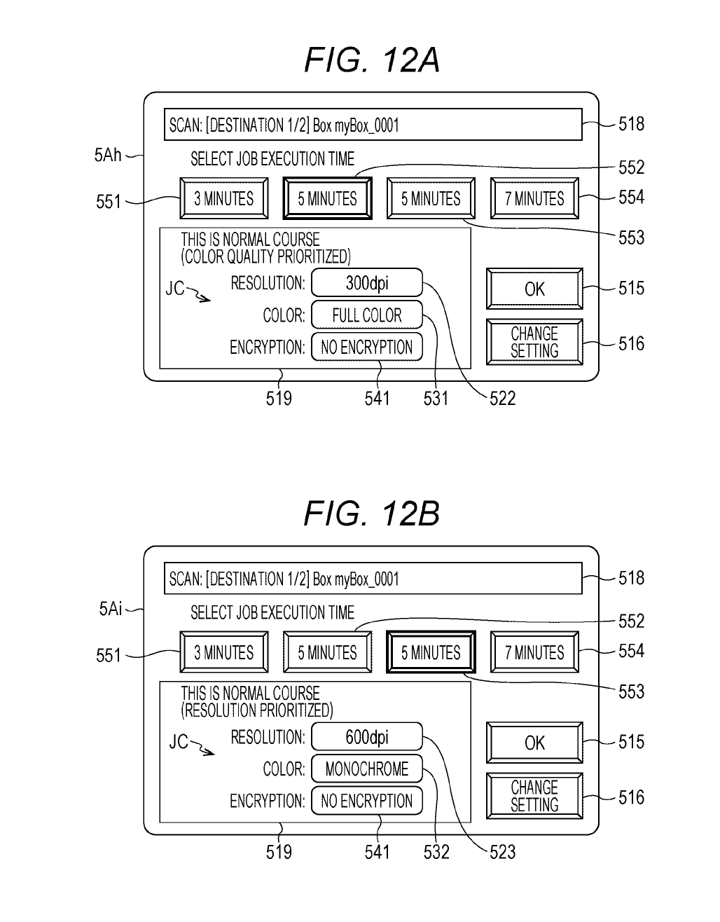

In the example of FIGS. 12A and 12B, four predicted times TJ are displayed on the same screen as options for selecting any of the four conditions JC.

Referring to the condition table 6C illustrated in FIG. 7, the condition JC allocated to each of the subgroups 8a and 8c is six while the condition JC allocated to each of the subgroups 8b and 8d is three.

Accordingly, the number of time selection buttons can be set to four, five, or six for the subgroups 8a and 8c, while the number of time selection buttons can be set to three for the subgroups 8b and 8d, similarly to the above examples of FIGS. 8A to 8C, 10A and 10B, and 12A and 12B. In the example of FIGS. 12A and 12B, the number is set to four.

Each of condition selection screens 5Ah and 5Ai illustrated in FIGS. 12A and 12B includes four time selection buttons 551, 552, 553, and 554, the OK button 515, the setting change button 516, the destination display region 518, the condition display region 519, or the like.

The time selection buttons 551, 552, 553, and 554 each correspond to the very quick course, the normal course #1, the normal course #2, and the fine course respectively, with the predicted time TJ calculated by the above-described predicted time calculation unit 106 being displayed in the form of a button name. In the illustrated example, the predicted time TJ of each of the four courses is 3, 5, 5, and 7 minutes. As in this example, the predicted times TJ of a plurality of courses might be the same in some cases.

The condition display region 519 displays the condition JC corresponding to the selected one course among the four courses (very quick course, the normal course #1, the normal course #2, and the fine course). That is, each of “300 dpi”, “Full color”, and “No Encryption” as the setting value of each of the conditions JC of the normal course #1 is displayed as the button name of each of the operation buttons 522, 531, and 541 respectively on the condition selection screen 5Ah of FIG. 12A. Moreover, each of “600 dpi”, “Monochrome”, and “No Encryption” as the setting value of each of the conditions JC of the normal course #2 is displayed as the button name of each of the operation buttons 523, 532, and 541 respectively on the condition selection screen 5Ai of FIG. 12B.

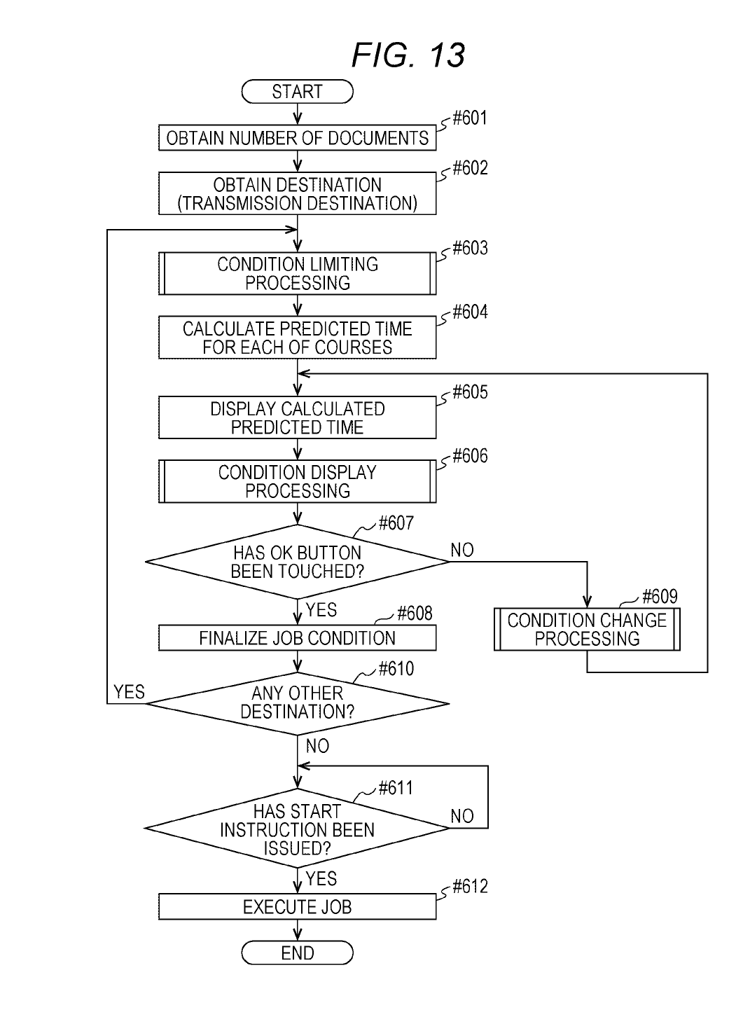

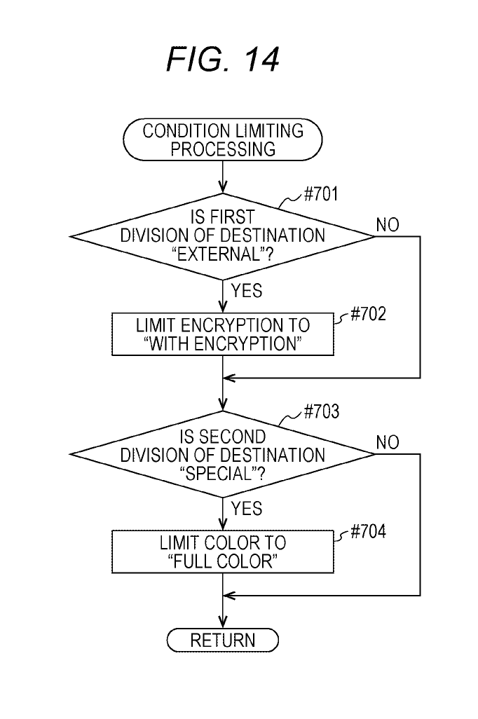

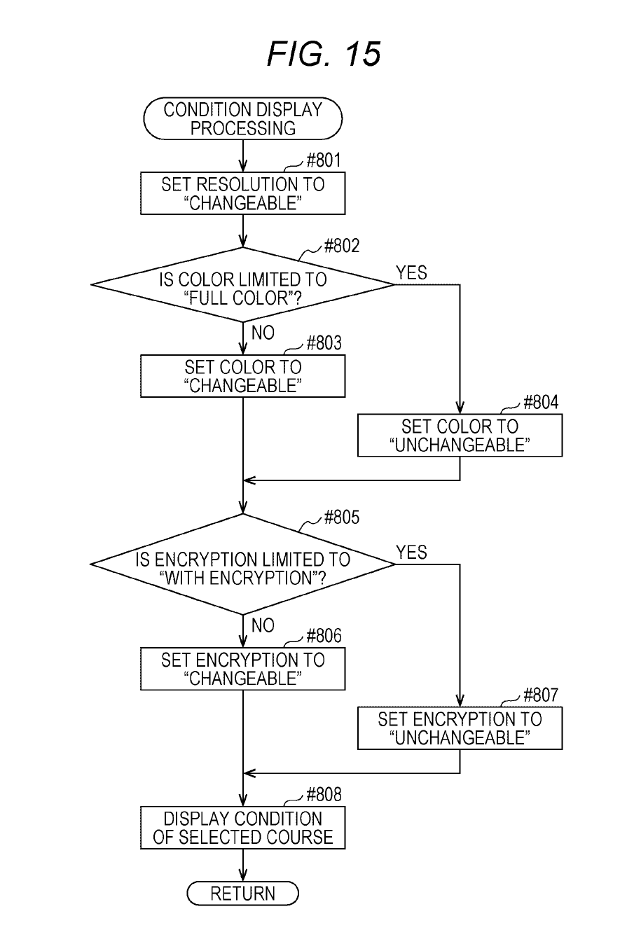

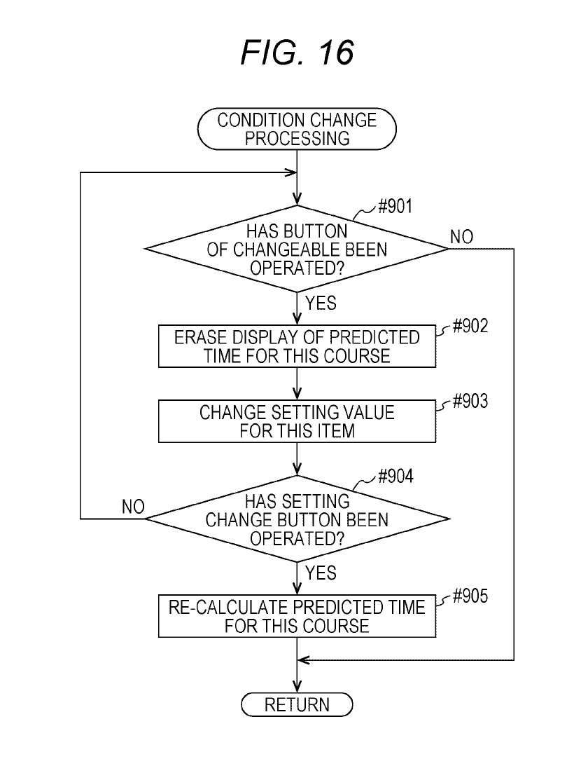

FIG. 13 illustrates a processing flow of the image processing apparatus 1. FIG. 14 illustrates a condition limiting processing flow. FIG. 15 illustrates a condition displaying processing flow. FIG. 16 illustrates a condition change processing flow.

As illustrated in FIG. 13, the image processing apparatus 1 obtains the number N of the set documents 2 (#601) and then displays the destination input screen 4A to receive the input of the destination (transmission destination) by a user (#602). The image processing apparatus 1 subsequently performs condition limiting processing of limiting the condition JC for one or a plurality of destinations input by the user (#603).

The image processing apparatus 1 calculates the predicted time TJ taken for executing a scan transmission job under the condition JC of each of the courses, for each of three, four, or more courses preset as a display target (#604). Subsequently, by setting the calculated plurality of predicted times TJ as the button names of the selection buttons, the buttons are all displayed together on the same screen as options for selecting any of the plurality of conditions JC (#605). Then, the apparatus performs condition display processing of simultaneously displaying the condition JC corresponding to the selected predicted time TJ on the same screen as the plurality of predicted times TJ (#606).

In a case where there is no operation onto the OK button 515 in a state where the condition JC corresponding to the selected predicted time TJ is displayed (NO in #607), the apparatus performs condition change processing of changing the setting value of the condition JC (#609).

In a case where there is operation onto the OK button 515 (YES in #607), the displayed condition JC is finalized. That is, the displayed conditions are set as conditions to be applied at the time of job execution (#608). If a plurality of destinations is specified and there is a destination for which the condition JC has not been finalized (YES in #610), the processing returns to step #603 and the processing of steps #603 to #609 are to be repeated.

In a case where there is no destination for which the condition JC has not been finalized (NO in #610), the job is executed in response to a start instruction input given by the user (#611 and #612).

As illustrated in FIG. 14, in the condition limiting processing, in a case where the first division 6d of the destination is “external” (YES in #701), the encryption setting value is limited to “with encryption” (#702). In a case where the first division 6d is not “external” (NO in #701), the setting value of the encryption is not to be limited. That is, the user is allowed to change the setting value.

In a case where the destination second division 6e is “Special” (YES in #703), the color setting value is limited to “Full color” (#702). In a case where the second division 6e is not “Special” (NO in #703), the setting value of the color is not to be limited.

In the condition display processing as illustrated in FIG. 15, firstly, the display mode of each of the operation buttons 521 to 523 that display the setting values of the resolution is set to a normal mode indicating the changeable setting value (#801).

In a case where the setting value of the color is limited to “Full color” (YES in #802), the display mode of the operation buttons 531 and 532 for displaying the setting value of the color is set to an operation invalid mode (for example, grayed out) (#804). In a case where the setting value of the color is not limited to “Full color” (NO in #802), the display mode of the operation buttons 531 and 532 is set to a normal mode (#803).

In a case where the encryption setting value is limited to “With Encryption” (YES in #805), the display mode of the operation buttons 541 and 542 for displaying the encryption setting value is set to the operation invalid mode (#807). In a case where the encryption setting value is not limited to “With Encryption” (NO in #805), the display modes of the operation buttons 541 and 542 are set to the normal mode (#806).

Thereafter, the condition JC of the course corresponding to the selected predicted time TJ is displayed as the button names of the operation buttons 521 to 523, 531, 532, 541, and 542 in the set display mode (#609).

In the condition change processing as illustrated in FIG. 16, in a case where there is no operation of the operation button in the normal mode corresponding to the changeable item (NO in #901), the processing immediately returns to the flow in FIG. 13.

In a case where there is operation of the operation button in the normal mode (YES in #901), the display of the predicted time TJ of the course is erased (#902), and the setting value of the item is changed (#903). When the setting change button 516 is thereafter operated (YES in #904), the predicted time TJ of the course is calculated again (#905).

According to the above embodiment, since the predicted time TJ of a plurality of courses is displayed, it is possible to enhance the convenience of the image processing apparatus 1 for a user who wishes to know the time requirement of the job at the time of inputting the scan transmission job, more than the conventional technique.

Since the condition JC for the very quick course is selectably displayed together with the predicted time TJ of the very quick course having the shortest time requirement among the plurality of selectable conditions JC, enabling the user in a hurry to avoid wasteful operation trying to designate the quickest condition JC.

According to the above-described embodiment, the predicted time TJ corresponding to each of the condition of the very quick course, the condition of the normal course having longer time requirement for a job, and the condition of the fine course further taking longer time requirement is to be displayed as options for selecting any one of these conditions. With this display, the user can select the job condition with knowledge of approximate time requirement of each of the conditions.

In the above-described embodiment, it is possible to adopt a technique of inputting the number N of the documents 2 by the user as a method for specifying the number of images to be transmitted after being converted into data. In a case where both sides of the document 2 are to be read, a detected thickness or weight value of the document 2 or the number N of the documents 2 specified on the basis of the user input value is doubled and this value may be reflected to the calculation of the predicted time TJ as the number of images.

In a case where the document 2 is not set on the automatic document feeder 12 but instead that the document 2 is detected to be placed on the platen glass of the scanner 13, calculation of the predicted time TJ may be performed with the number N of sheets of the document 2 set to “1”.

While the embodiment described above sets the fixed size of the document 2, it is allowable make it unfixed and to calculate the predicted time TJ corresponding to individual sizes. For example, it is allowable to provide a per-sheet time requirement table 6D for each of a plurality of assumed sizes, and calculate the predicted time TJ by using the per-sheet time requirement table 6D for the size closest to the size detected by the sensor or to the size input by the user.

While the embodiment described above describes the condition JC corresponding to one predicted time TJ selected together with the plurality of predicted times TJ, the present invention is not limited to this display method. In a case where there is sufficient space on a display surface of the display, a plurality of conditions corresponding to each of these predicted times TJ may be displayed together with a plurality of predicted times TJ, on the same screen.

In displaying on the same screen, it is better to display at the same time as long as there is enough space on the display surface of the display. Still, in a case where simultaneous display is not practical, it would be sufficient to allow them to be displayed together by scrolling or touching the display surface.

The predicted time TJ may be calculated for all of selectable plurality of conditions JC depending on the group to which the destination belongs and displayed together. For example, in a case where the destination belongs to the subgroup 8a, 12 conditions JC, including the case where “with encryption” is set, and thus, 12 predicted times TJ and 12 conditions JC are to be displayed together. In a case where the destination belongs to the subgroup 8c, six predicted times TJ and six conditions JC are to be displayed together.

In addition, appropriately the configuration of the whole or each part of the image processing apparatus 1, details of processing, the order or timing of the processing, details of the condition table 6C or other tables, the layout of the condition selection screen 5A, the calculation formula of the predicted time TJ, etc. can be changed in accordance with the scope and the spirit of the present invention.

Although embodiments of the present invention have been described and illustrated in detail, the disclosed embodiments are made for purposes of illustration and example only and not limitation. The scope of the present invention should be interpreted by term of the appended claims.

What is claimed is:

1. An image processing apparatus that performs a job of converting an image of a document into data and transmitting the generated image data, the image processing apparatus comprising:
a display that displays a screen on which a user designates a transmission destination;
a calculator that calculates a predicted time taken to perform the job under each of a plurality of conditions having mutually different setting values in converting the image into image data;
a display controller that controls to display the predicted times individually calculated for the plurality of conditions on the display; and
a job execution controller that controls to execute the job under a selected condition out of the plurality of conditions.

2. The image processing apparatus according to claim 1,
wherein the display controller controls to display the predicted times of the plurality of conditions individually on the same screen as options for selecting one of the plurality of conditions.

3. The image processing apparatus according to claim 1,
wherein the plurality of conditions includes three conditions of: a first condition; a second condition that takes a longer time to perform the job than the first condition; and a third condition that takes a longer time to perform the job than the second condition, and
the display controller controls to display the predicted times of the three conditions individually out of the plurality of conditions on the same screen as options for selecting any of the three conditions.

4. The image processing apparatus according to claim 2,
wherein the display controller controls to display the plurality of calculated predicted times and the condition corresponding to the selected predicted time out of the plurality of conditions, on the same screen.

5. The image processing apparatus according to claim 4,
wherein the display controller controls to display the condition corresponding to the selected predicted time in a form of an operation button for instructing a change of the condition.

6. The image processing apparatus according to claim 1,
wherein, in a case where the designated transmission destination belongs to a first group, the calculator selects a condition of performing encryption as each of the plurality of conditions, and, in a case where the designated transmission destination belongs to a second group different from the first group, the calculator selects a condition of not performing encryption as each of the plurality of conditions.

7. The image processing apparatus according to claim 6,
wherein, in a case where the designated transmission destination belongs to either of the first group and the second group, and belongs to a third group at the same time, the calculator selects a condition for performing reading in color as each of the plurality of conditions.

8. The image processing apparatus according to claim 1, further comprising
a detector that detects the number of the documents,
wherein the calculator calculates the predicted time by using a calculation formula including the detected number as a variable.

9. The image processing apparatus according to claim 1,
wherein in a case where a plurality of the transmission destinations is designated, the display controller controls to display the predicted time for each of the destinations.

10. A non-transitory recording medium storing a computer readable program to be applied in an image processing apparatus that performs a job of converting an image of a document into data and transmitting the generated image data, the program causing the image processing apparatus to execute:
calculating a predicted time taken to perform the job under each of a plurality of conditions having mutually different setting values in converting the image into data;
displaying the predicted times individually calculated for the plurality of conditions on a display; and
performing the job under a selected condition out of the plurality of conditions.
